(19) United States
(12) Patent Application Publication
(10) Pub. No.: US 2025/0111053 A1
(43) Pub. Date: Apr. 3, 2025

(54) ATTESTATION METHODS

(71) Applicant: BRITISH TELECOMMUNICATIONS PUBLIC LIMITED COMPANY, London, Greater London (GB)

(72) Inventors: Ali SAJJAD, London, Greater London (GB); Syed ZIA, London, Greater London (GB); Jamshed MEMON, London, Greater London (GB); Mamun ABU-TAIR, London, Greater London (GB)

(21) Appl. No.: 18/721,474

(22) PCT Filed: Nov. 21, 2022
(86) PCT No.: PCT/EP2022/082647

§ 371 Date: Jun. 18, 2024

(30) Foreign Application Priority Data
Dec. 22, 2021 (GB) 2118712.5

(51) Int. Cl. G06F 21/57; H04L 9/32

(52) U.S. Cl. CPC G06F 21/57; H04L 9/3234

(57) ABSTRACT

Attestation method for verifying the integrity of an attester device by an attestation proxy (AP): sending a trusted platform module (TPM) quote request message directly to a virtual TPM (vTPM) uniquely associated with the attester device, to prompt the vTPM to: produce a set of platform configuration register (PCR) values based on measurements requested and received by the vTPM directly from the attester device, then send a TPM quote comprising the set of PCR values directly to the AP; the attestation method further comprising the AP: receiving the TPM quote; sending the TPM quote to a remote relying party (RP) to prompt the RP to: verify the TPM quote is as expected, then return a remote attestation indicator to the AP; receiving the remote attestation indicator; and producing an attestation result based on the remote attestation indicator, wherein the attestation result is negative when the remote attestation indicator is negative.

### FIELD

The present disclosure relates to attesting to the integrity of devices.

More specifically, aspects relate to attestation methods for verifying the integrity of devices, data processing systems configured to perform such attestation methods, network gateway devices comprising such data processing systems, computer programs comprising instructions which, when executed by a computer, cause the computer to carry out such methods, computer-readable data carriers having stored thereon such computer programs and data carrier signals carrying such computer programs.

### BACKGROUND

Trusted Platform Module (TPM, also known as ISO/IEC 11889) is an international standard for a secure crypto-processor. It is usually implemented as a dedicated microcontroller designed to secure hardware through integrated cryptographic keys. The attestation protocol specified in the TPM specification involves a TPM chip measuring the current state of a platform (computer device) to produce a TPM quote. This TPM quote is cryptographically signed using keys permanently burned into the chip and used to attest to platform integrity to a Relying Party (RP, usually the device manufacturer), which stores measurements representing the original platform state. This can for example be done to check a device has not been tampered with between leaving a manufacturer and arriving at an end user's premises, before it is permitted to join a local network or access a non-local network, such as the Internet.

However, there are several problems with the TPM specification, including the following.
Integration of a TPM chip is not always possible, for example for Internet of Things (IoT) devices such as sensors which often have severe size and resource constraints.
TPM chips only have basic capabilities; their memory is limited, and they operate via sequential, single-threaded execution.
TPM chips are tied to their manufacturer so ownership of a device comprising a TPM chip cannot be transferred without the TPM functionality being lost unless the manufacturer ‘unlocks’ the TPM chip.
The serial interface bus of a TPM chip generally provides no protection mechanisms (communication is not encrypted) and is easy to access with simple equipment. Consequently, the signals transported via this bus are vulnerable to manipulation.
There is a security risk associated with allowing the attester device to communicate with the RP before its integrity has been verified.
The attester device and the RP must both stay online throughout the attestation process, which may not always be achievable in practice if connections are not sufficiently robust.
If multiple devices associated with an end user require attestation, then they must all undergo individual exchanges with the RP.
Direct communication (or at least only transparent intermediaries, i.e. intermediaries which do not modify contents of messages they relay) is required between the TPM chip and the RP, which is very difficult to achieve in modern networks.
To establish an initial root of trust on the attester device, an admin user of the device must manually verify a certificate stored in the TPM chip.

What is needed is a way of attesting to the integrity of a device which overcomes at least some of these problems.

### SUMMARY

According to a first aspect, there is provided an attestation method for verifying the integrity of an attester device by an attestation proxy (AP) which is a node of a distributed ledger (DL) network;
the attestation method comprising the AP:
   sending a trusted platform module (TPM) quote request message directly to a virtual TPM (vTPM) uniquely associated with the attester device, to prompt the vTPM to:
      produce a set of platform configuration register (PCR) values based on measurements requested and received by the vTPM directly from the attester device,
      then send a TPM quote comprising the set of PCR values directly to the AP;
the attestation method further comprising the AP:
   receiving the TPM quote;
   retrieving, from a local copy of the DL, a latest set of PCR values recorded for the attester device;
   comparing that set of PCR values retrieved from the local copy of the DL with the set of PCR values received in the TPM quote to generate a local attestation indicator, wherein the local attestation indicator is negative when the set of PCR values retrieved from the local copy of the DL does not match the set of PCR values received in the TPM quote; and
   producing an attestation result based on the local attestation indicator, wherein the attestation result is negative when the local attestation indicator is negative.

The attestation method can further comprise the AP:
obtaining an indication that a user wishes the attester device to join a network in which the AP is comprised, the step of sending the TPM quote request message being responsive thereto; and
determining whether to validate the attester device for joining the network in dependence on the attestation result, wherein the AP prevents the attester device from joining the network when the attestation result is negative.

The TPM quote request message can prompt the vTPM to cryptographically sign the TPM quote; and
the attestation method can further comprise the AP verifying the vTPM's signature of the TPM quote before producing the attestation result, wherein the attestation result is negative when verification of the vTPM's signature of the TPM quote fails.

A unique public/private endorsement key-pair (EK) can be generated in advance by a trusted authority, the AP having read access to an EK certificate comprising the EK public key and the EK private key being comprised in the vTPM;
the attestation method can further comprise the AP:
   prior to sending the TPM quote request message, sending a certificate request message to the vTPM to prompt the vTPM to return to the AP an AK certificate comprising an AK public key cryptographically signed by the EK private key, the AK public key being the public component of a public/private attestation key-pair (AK) generated by the vTPM;
   receiving the signed AK certificate; and
   verifying the vTPM's signature of the AK certificate using the EK public key before producing the attestation result, wherein the attestation result is negative when verification of the vTPM's signature of the AK certificate fails;
wherein the TPM quote request message can prompt the vTPM to cryptographically sign the TPM quote with the AK private key.

The attestation method can further comprise the AP:
constructing the TPM quote request message to comprise a local attestation nonce, wherein the TPM quote request message prompts the vTPM to construct the TPM quote to comprise that local attestation nonce; and
checking whether the local attestation nonce received in the TPM quote matches the local attestation nonce sent in the TPM quote request message, wherein the attestation result is negative if it does not.

The attestation method can further comprise the AP submitting a record of the attestation result to the DL for storage.

The attestation method can further comprise the AP retrieving the attester device's network access requirements from the local copy of the DL;
wherein the attestation result can be produced based on said network access requirements.

The AP can be a movable network element which resides on a network-attached device, and the attestation method can further comprise:
determining that performance of the network-attached device on which the AP resides does not satisfy an AP performance criterion; and
responsive thereto, initiating transfer of the AP to an alternative network-attached device.

The vTPM can be a movable network element which resides on a network-attached device, and the attestation method can further comprise:
determining that performance of the network-attached device on which the vTPM resides does not satisfy a vTPM performance criterion; and
responsive thereto, initiating transfer of the vTPM to an alternative network-attached device.

The attestation method can further comprise the AP, prior to producing the attestation result:
sending the TPM quote to a remote relying party (RP) to prompt the RP to verify the TPM quote is as expected then return a remote attestation indicator to the AP; and
receiving the remote attestation indicator;
   wherein the attestation result is negative when the remote attestation indicator is negative.

According to a second aspect, there is provided an attestation method for verifying the integrity of an attester device by an attestation proxy (AP):
sending a trusted platform module (TPM) quote request message directly to a virtual TPM (vTPM) uniquely associated with the attester device, to prompt the vTPM to:
   produce a set of platform configuration register (PCR) values based on measurements requested and received by the vTPM directly from the attester device,
   then send a TPM quote comprising the set of PCR values directly to the AP;
      the attestation method further comprising the AP:
receiving the TPM quote;
sending the TPM quote to a remote relying party (RP) to prompt the RP to:
   verify the TPM quote is as expected,
   then return a remote attestation indicator to the AP;
receiving the remote attestation indicator; and
producing an attestation result based on the remote attestation indicator, wherein the attestation result is negative when the remote attestation indicator is negative.

The attestation method can further comprise the AP:
obtaining an indication that a user wishes the attester device to join a network in which the AP is comprised, the step of sending the TPM quote request message being in response to obtaining said indication; and
determining whether to validate the attester device for joining the network in dependence on the attestation result, wherein the AP prevents the attester device from joining the network when the attestation result is negative.

The AP can be a node of a distributed ledger (DL) network, the RP can have read access to the DL, and the attestation method can further comprise the AP:
publishing the set of PCR values received in the TPM quote to the DL.

The attestation method can further comprise the AP retrieving the attester device's network access requirements from the DL;
wherein the attestation result can be produced based on said network access requirements.

The AP can be a movable network element which resides on a network-attached device, and the attestation method can further comprise:
determining that performance of the network-attached device on which the AP resides does not satisfy an AP performance criterion; and
responsive thereto, initiating transfer of the AP to an alternative network-attached device.

The vTPM can be a movable network element which resides on a network-attached device, and the attestation method can further comprise:
determining that performance of the network-attached device on which the vTPM resides does not satisfy a vTPM performance criterion; and
responsive thereto, initiating transfer of the vTPM to an alternative network-attached device.

The attestation method can further comprise the AP:
prior to sending the TPM quote to the RP, establishing a communication session with the RP by sending a first remote attestation nonce to the RP and receiving a second remote attestation nonce from the RP; and
sending the first and second remote attestation nonces to the RP together with the TPM quote, to prompt the RP to verify the first and second remote attestation nonces it received together with the TPM quote match the first and second remote attestation nonces previously exchanged with the AP, wherein the attestation result is negative when verification of either of the first and second remote attestation nonces fails.

The attestation method can further comprise the AP, prior to sending the TPM quote to the RP:
securely sending a session secret to the RP; and
encrypting the TPM quote using a symmetric cipher based on the session secret.

The AP can be a node of a/the distributed ledger (DL) network; and the attestation method can further comprise the AP:
retrieving, from a local copy of the DL, a latest set of PCR values recorded for the attester device; and
comparing that set of PCR values retrieved from the local copy of the DL with the set of PCR values received in the TPM quote to produce a local attestation indicator, wherein the local attestation indicator is negative when the set of PCR values retrieved from the local copy of the DL does not match the set of PCR values received in the TPM quote;
   wherein the attestation result is negative when the local attestation indicator is negative.

According to a third aspect, there is provided a data processing system configured to perform the attestation method of either of the first or second aspects.

According to a fourth aspect, there is provided a network gateway device comprising the data processing system of the third aspect.

According to a fifth aspect, there is provided a computer program comprising instructions which, when the program is executed by a computer, cause the computer to carry out the method of either of the first or second aspects.

According to a sixth aspect, there is provided a computer-readable data carrier having stored thereon the computer program of the fifth aspect.

According to a seventh aspect, there is provided a data carrier signal carrying the computer program of the fifth aspect.

### BRIEF DESCRIPTION OF THE FIGURES

Aspects of the present disclosure will now be described by way of example with reference to the accompanying figures. In the figures:

FIG. 1 illustrates an example system in which the attestation methods described herein can be implemented;

FIG. 2 illustrates an example local attestation method;

FIG. 3 illustrates an example remote attestation method;

FIG. 4A illustrates an example preparation process;

FIG. 4B illustrates an example device on-boarding process;

FIG. 4C illustrates an example local attestation process;

FIG. 4D illustrates an example remote attestation process.

### DETAILED DESCRIPTION OF THE FIGURES

The following description is presented to enable any person skilled in the art to make and use the system and/or perform the method of the invention and is provided in the context of a particular application. Various modifications to the disclosed embodiments will be readily apparent to those skilled in the art.

It is proposed to run an ‘attestation proxy’ (AP) on a device local to a device requiring attestation (an ‘attester device’) to enact a novel local attestation protocol. Alternatively, it is proposed for an AP to enact a novel remote attestation protocol in which the AP acts as an intermediary between the attester device and an RP. Local and remote attestation can also be performed together as a two-stage attestation method.

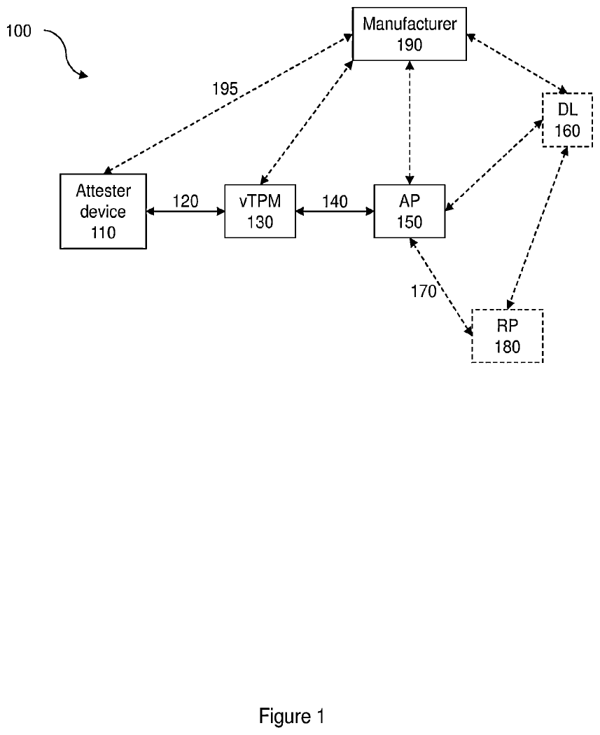

FIG. 1 illustrates an example system 100 in which the local, remote, and two-stage attestation methods described herein can be implemented. An attester device 110, such as an IoT device, is provided with a two-way communication link 120 with a virtual TPM (vTPM) 130 running in a secure virtual environment. The vTPM 130 is in turn provided with a two-way communication link 140 with an AP 150. For local and two-stage attestation, and for some remote attestation implementations, the AP 150 is a node of a distributed ledger (DL) network 160. For remote attestation, the AP 150 is further provided with a two-way communication link 170 with an RP 180, which in some implementations is a node of the DL network 160. FIG. 1 also shows a manufacturer 190 of the attester device 110, which has a direct communication link 195 with the attester device 110 during preparation for distribution of the attester device 110. In some implementations the manufacturer 190 has one-way or two-way communication links with one or more of the vTPM 130, AP 150 and DL 160. In implementations where attestation data is stored on the DL 160, it is possible for the DL to be updated to reflect changes in ownership of the attester device 110 and/or legitimate updates to the attester device 110, such as firmware and/or operating system (OS) updates.

In some implementations, the attestation may be a prerequisite for allowing the attester device 110 to join a local network and/or be provided with access to a non-local network such as the Internet. The AP 150 can for example be run on a network gateway device configured to control access to a local network and/or an Internet connection.

The vTPM 130 and AP 150 can for example be movable network elements which can be run on any suitable data processing device. One or both of the vTPM 130 and the AP 150 can for example be run on a network gateway device. One or both of the vTPM 130 and the AP 150 can for example be run on another device, such as a personal computer (PC), which can for example be attached to (i.e. provided with network access by) such a network gateway device. One or both of the vTPM 130 and AP 150 can be run on multiple devices, allowing multiple processes to be run in parallel and speeding up the attestation process relative to that permitted by sequential single-threaded execution on a physical TPM chip.

In implementations in which the AP 150 is a movable network element, such as a mobile agent, it can be moved to run on an alternative network-attached device if a determination is made, e.g. by the AP 150, that the performance of the network-attached device on which it resides does not satisfy an AP performance criterion, such as a throughput or latency criterion. This movement can be done at runtime. It could for example be initiated by the AP 150 and performed in conjunction with a software process or agent on the destination device (that is, the device the AP 150 is being moved to). The destination device may for example have greater processing and/or memory resources than the device on which the AP 150 is initially run.

In implementations in which the vTPM 130 is a movable network element, such as a software application, software library, application container or a virtual machine, it can be moved to run on an alternative network-attached device if a determination is made, e.g. by the AP 150, that the performance of the network-attached device on which the vTPM 130 resides does not satisfy a vTPM performance criterion, such as a minimum TPM quote generation time. This movement can be done at runtime. It could for example be initiated by the AP 150 and performed in conjunction with a software process or agent on the destination device (that is, the device the vTPM 130 is being moved to). The destination device may for example have greater processing and/or memory resources than the device on which the vTPM 130 is initially run.

The two-way communication link 120 between the attester device 110 and the vTPM 130 is a direct communication link. That is, the two-way communication link 120 between the attester device 110 and the vTPM 130 permits communication between the attester device 110 and a device on which the vTPM 130 runs without involving any intermediary devices. Similarly, the two-way communication link 140 between the vTPM 130 and the AP 150 is a direct communication link. That is, the two-way communication link 140 between the vTPM 130 and the AP 150 permits communication between a device on which the vTPM 130 runs and a device on which the AP 150 runs without involving any intermediary devices. The other communication links shown, where present, may be direct or indirect.

FIG. 1 shows only a single attester device 110 for clarity, but a single AP 150 can serve multiple attester devices 110. Where a plurality of attester devices 110 are present, each is uniquely associated with its own individual vTPM 130. The DL 160 and RP 180 (where present) and the manufacturer 190 may all be specific to a particular attester device 110, or shared between two or more of a plurality of attester devices 110.

### Local Attestation

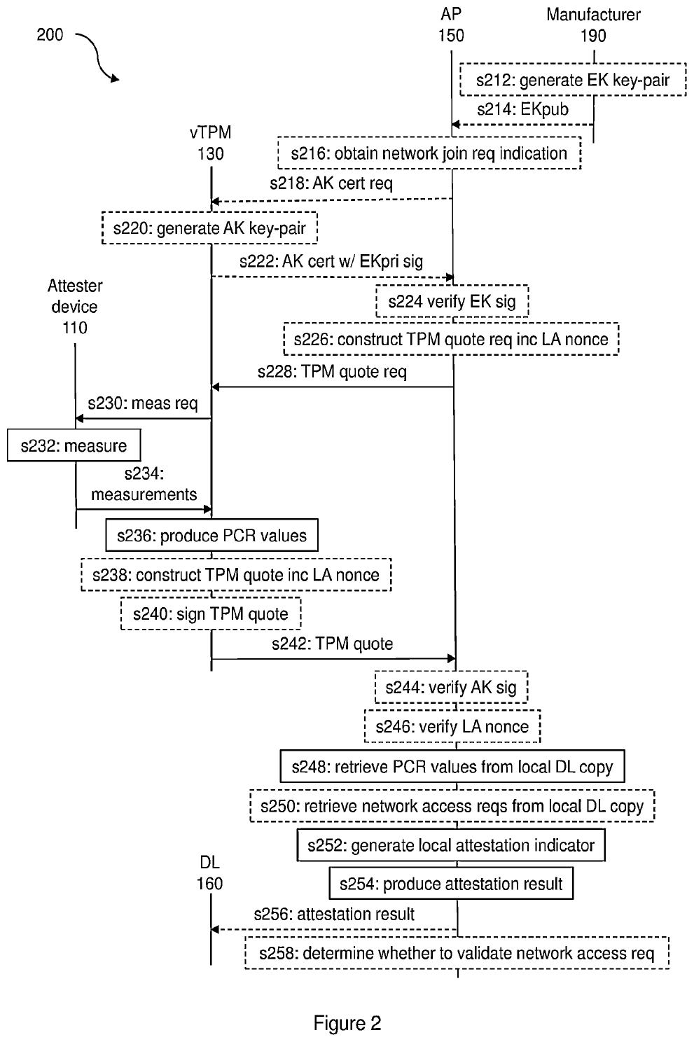

FIG. 2 illustrates an example local attestation method 200 for verifying the integrity of an attester device 110 by an AP 150. In this local attestation method 200, the AP 150 is a node of a DL network 160. The RP 180 and the AP 150's two-way communication link to it 170 as shown in FIG. 1 are not required for the local attestation method 200.

Considering first the core steps of the local attestation method 200, at step s228 the AP 150 sends a TPM quote request (req) message directly to the vTPM 130 uniquely associated with the attester device 110. This prompts the vTPM 130 at step s230 to send a measurement request (meas req) message to the attester device 110, for example requesting measurements representing its state such as hashes of the device's firmware, boot loader and OS kernel. These measurements are made by the attester device 110 at step s232 and received by the vTPM 130 at step s234. The vTPM 130 then produces a set of platform configuration register (PCR) values based on the measurements at step s236. In some examples the set of PCR values has one-to-one correspondence with the measurements. In other examples the measurements are combined into one or more PCR values, for example via operations such as fold-hashing.

The vTPM 130 sends a TPM quote comprising the set of PCR values directly to the AP 150, which receives the TPM quote at step s242. At step s248 the AP 150 then retrieves a latest set of PCR values recorded for the attester device 110 from a local copy of the DL. The AP 150 compares that set of PCR values retrieved from its local copy of the DL with the set of PCR values received in the TPM quote to generate a local attestation indicator at step s252. (The local attestation indicator generated at step s252 is always negative when the set of PCR values retrieved from the local copy of the DL at step s248 does not match the set of PCR values received in the TPM quote at step s242. It may be positive otherwise, depending on what other factors, if any, apply in the specific implementation.) The AP 150 then produces an attestation result based on the local attestation indicator at step s254. (The attestation result produced at step s254 is always negative when the local attestation indicator generated at step s252 is negative. It may be positive otherwise, depending on what other factors, if any, apply in the specific implementation.)

According to the local attestation method 200, the attester device 110's integrity can be checked without any need for it to comprise a physical TPM chip, and without any communication with a remote RP being required. This means that attestation can be performed even if a communication link to a remote RP is not available. Further, there is no need to expose any devices other than those on which the AP 150 and vTPM 130 are running to the untrusted attester device 110 prior to attestation.

In some implementations, at optional step s216 the AP 150 can obtain an indication that a user wishes the attester device 110 to join a network in which the AP 150 is comprised (obtain network join req indication). Such an indication may for example come from a device on-boarding service (e.g. running on the same device as the AP 150) or the AP 150 may receive a request from the attester device 110, or the AP 150 may receive direct user input through a user interface device comprised in the device it is running on. Requesting the TPM quote at step s228 may be performed in response to obtaining the indication that a user wishes the attester device 110 to join the network at step s216. In response to the attestation result being produced at step s254, the AP 150 can determine at optional step s258 whether to validate the attester device 110 for joining the network (determine whether to validate network access req), in dependence on the attestation result. (In these implementations the AP 150 always determines to prevent the attester device 110 from joining the network at step s258 when the attestation result produced at step s254 is negative. It may validate the attester device 110 to join the network otherwise, depending on what other factors, if any, apply in the specific implementation.)

In some implementations, the TPM quote request message sent at step s228 prompts the vTPM 130 to cryptographically sign the TPM quote at optional step s240. The AP 150 then verifies the vTPM 130's signature (sig) of the TPM quote at optional step s244 at some point between receiving the TPM quote at step s242 and producing the attestation result at step s254. (In these implementations the attestation result produced at step s254 is always negative when verification of the vTPM's signature of the TPM quote at step s244 fails.) In some of these implementations a unique public/private endorsement key-pair (EK) is generated by a trusted authority, such as the manufacturer 190 of the attester device 110, at optional step s212. The AP 150 is then provided with read access to an EK certificate comprising the EK public key (EKpub) at optional step s214. (This provision of the EK public key to the AP 150 at step s214 could for example serve as the indication of step s216 that the user wishes the attester device to join the network.) In these implementations, the vTPM 130 is constructed to comprise the EK private key in such a way that the EK private key cannot be retrieved from the vTPM 130. The vTPM 130 generates a public/private attestation key-pair (AK) at optional step s220 and stores the AK private key in such a way that it cannot be retrieved from the vTPM 130. Prior to sending the TPM quote request message at step s228, the AP 150 sends an AK certificate request (cert req) message to the vTPM 130 at optional step s218. This prompts the vTPM 130 to send to the AP 150 an AK certificate (cert) comprising the AK public key cryptographically signed by the EK private key (EKpri), which is received by the AP 150 at optional step s222. The AP 150 then verifies the vTPM 130's signature (sig) of the AK certificate using the EK public key at optional step s224, which is performed at some point after both obtaining the EK public key at step s214 and receiving the AK certificate at step s222, and before producing the attestation result at step s254. (In these implementations the attestation result is always negative when verification of the vTPM 130's signature of the AK certificate at step s224 fails.) In these implementations the AK private key is used to cryptographically sign the TPM quote at optional step s240.

In some implementations the AP 150 constructs the TPM quote request (req) message to comprise/include (inc) a local attestation (LA) nonce (which can for example be a random number generated by the AP 150) at optional step s226 and the vTPM 130 constructs the TPM quote to comprise/include (inc) that received local attestation nonce at optional step s238. Subsequently, at optional step s246 the AP 150 checks whether the local attestation nonce received in the TPM quote at step s242 matches the local attestation nonce sent in the TPM quote request message at step s228. (In these implementations, the attestation result produced at step s254 is always negative if it does not.)

In some implementations, at optional step s256 the AP 150 submits a record of the attestation result to the DL 160 for storage. This can be repeated each time the attester device 110's integrity is checked, to form a digitally signed integrity chain, which can for example comprise metadata relating to each attestation, such as the time it was carried out. Other parties can then query the DL to enable them to make informed decisions, based on the integrity of the attester device 110 throughout its lifecycle. This availability of historic attestation data for scrutiny or audit can foil replay attacks in which old PCR values, from prior to corruption of a device, are used in place of current values. This contrasts with physical TPM based systems, where the limited storage of the TPM chip does not generally permit any storage of historical data.

In some implementations, at optional step s250 the AP 150 retrieves the attester device 110's network access requirements (reqs) from the AP 150's local copy of the DL so that the attestation result is produced based on said network access requirements at step s254. For example, the attestation result would be negative if the attester device 110's network access requirements conflict with a network access policy of the AP 150 (e.g. if the attester device 110's network access requirements specify use of Hypertext Transfer Protocol (HTTP) while the AP 150 only allows Hypertext Transfer Protocol Secure (HTTPS)).

### Remote Attestation

While local attestation has many benefits, it does not allow for legitimate updates to the attester device 110, such as firmware or operating system updates. Therefore, a novel remote attestation protocol is also proposed, in which the AP 150 acts as an intermediary between the attester device 110 and an RP 180.

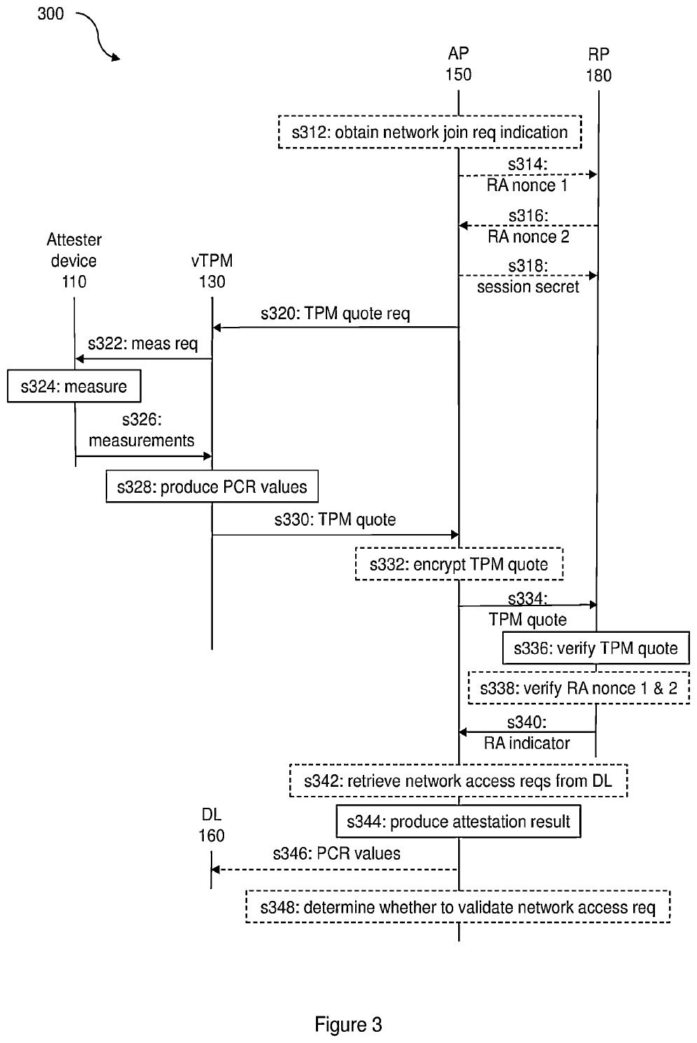

FIG. 3 illustrates an example remote attestation method 300 for verifying the integrity of an attester device 110 by an AP 150.

Considering first the core steps of the remote attestation method 300, at step s320 the AP 150 sends a TPM quote request (req) message directly to the vTPM 130 uniquely associated with the attester device 110. This prompts the vTPM 130 at step s322 to send a measurement request (meas req) message to the attester device 110, for example requesting measurements representing its state such as hashes of the device's firmware, boot loader and OS kernel. These measurements are made by the attester device 110 at step s324 and received by the vTPM 130 at step s326. The vTPM 130 then produces a set of PCR values based on the measurements at step s328. In some examples the set of PCR values has one-to-one correspondence with the measurements. In other examples the measurements are combined into one or more PCR values, for example via operations such as fold-hashing.

The vTPM 130 sends a TPM quote comprising the set of PCR values directly to the AP 150, which receives the TPM quote at step s330. The AP 150 then sends the TPM quote to the remote RP 180 at step s334. This prompts the RP to verify the TPM quote is as expected at step s336, then return a remote attestation (RA) indicator to the AP 150. The AP 150 receives the remote attestation indicator at step s340. The AP 150 then produces an attestation result based on the remote attestation indicator at step s344. (The attestation result produced at step s344 is always negative when the remote attestation indicator received at step s340 is negative. It may be positive otherwise, depending on what other factors, if any, apply in the specific implementation.)

According to the remote attestation method 300, the attester device 110's integrity can be checked without any need for it to comprise a physical TPM chip.

In some implementations, at optional step s312 the AP 150 can obtain an indication that a user wishes the attester device 110 to join a network in which the AP 150 is comprised (obtain network join req indication). Such an indication may for example come from a device on-boarding service (e.g. running on the same device as the AP 150) or the AP 150 may receive a request from the attester device 110, or the AP 150 may receive direct user input through a user interface device comprised in the device it is running on. Requesting the TPM quote at step s320 can be performed in response to obtaining the indication that a user wishes the attester device 110 to join the network at step s312. In response to the attestation result being produced at step s344, the AP 150 can determine at optional step s348 whether to validate the attester device 110 for joining the network (determine whether to validate network access req), in dependence on the attestation result. (In these implementations the AP 150 always determines to prevent the attester device 110 from joining the network at step s348 when the attestation result produced at step s344 is negative. It may validate the attester device 110 to join the network otherwise, depending on what other factors, if any, apply in the specific implementation.)

In some implementations, the AP 150 is a node of a DL network 160 and the RP has read access to the DL (the RP may also be a node of the DL network 160). The remote attestation method 300 can further comprise the AP 150 publishing the set of PCR values received in the TPM quote at step s330 to the DL 160 at optional step s346. The attestation result could alternatively or additionally be published to the DL, at the same time or separately. This can be repeated each time the attester device 110's integrity is checked, to form a digitally signed integrity chain, which can for example comprise metadata relating to each attestation, such as the time it was carried out. Other parties can then query the DL to enable them to make informed decisions, based on the integrity of the attester device 110 throughout its lifecycle. This availability of historic attestation data for scrutiny or audit can foil replay attacks in which old PCR values, from prior to corruption of a device, are used in place of current values. This contrasts with physical TPM based systems, where the limited storage of the TPM chip does not generally permit any storage of historical data.

In some of these implementations, at optional step s342 the AP 150 retrieves the attester device 110's network access requirements (reqs) from the DL (e.g. from the AP 150's local copy of the DL) so that the attestation result is produced based on said network access requirements at step s344. For example, the attestation result may be negative if the attester device 110's network access requirements conflict with a network access policy of the AP 150 (e.g. if the attester device 110's network access requirements specify use of HTTP while the AP 150 only allows HTTPS).

In some implementations, the AP 150, prior to sending the TPM quote to the RP 180 at step s334, establishes a communication session with the RP 180 by sending a first remote attestation nonce (RA nonce 1, which can for example be a random number generated by the AP 150) to the RP 180 at optional step s314 and receiving a second remote attestation nonce (RA nonce 2, which can for example be a random number generated by the RP 180) from the RP 180 at optional step s316. The first and second remote attestation nonces can then be sent by the AP 150 to the RP 180 together with the TPM quote at step s334, to prompt the RP 180 to verify at optional step s338 that they match the first and second remote attestation nonces previously exchanged with the AP 150 at optional steps s314 and s316. (The attestation result produced at step s344 is always negative when verification of either of the first and second remote attestation nonces at optional step s338 fails.)

In some implementations, the AP 150, prior to sending the TPM quote to the RP 180 at step s334, securely sends a session secret to the RP 180 at optional step s318. Security of the session secret can for example be achieved by encrypting it, e.g. with a public key associated with the RP 180. The TPM quote can then be encrypted by the AP 150 using a symmetric cipher based on the session secret at optional step s332. (Symmetric ciphers are generally faster and more secure than asymmetric ciphers.)

Since communication by the attester device 110 with the RP 180 goes through the AP 150, if multiple devices require remote attestation at the same time then the AP 150 can handle all the remote attestations as a batch, reducing the communication resources required. For example, steps s314, s316, s318, s332, s334, s336, s338, s340, s344 and s346 can all be performed in respect of multiple attester devices at once.

### Two-Stage Attestation

The local attestation method 200 of FIG. 2 can be performed in conjunction with the remote attestation method 300 of FIG. 3. For example, the local attestation method 200 can be performed initially to confirm the attester device 110's integrity to a standard sufficient to permit the remote attestation method 300 to be performed. (Local attestation is performed first since, relative to remote attestation, local attestation limits exposure of devices other than those directly involved in the attestation process to the attester device 110.)

Such a two-stage attestation need not incorporate every step of the local attestation method 200 as well as every step of the remote attestation method 300, since some of these steps are duplicates or perform a similar function; for example once one or more of steps s216, s250, s254, s256 and s258 have been performed, one or more of steps s312, s342, s344, s346 and s348 may respectively be omitted as redundant, or vice-versa, in some implementations.

In two-stage attestation, the attestation result is produced based on both a local attestation indicator and a remote attestation indicator, with the attestation result being negative if either or both of the local and remote attestation indicators are negative.

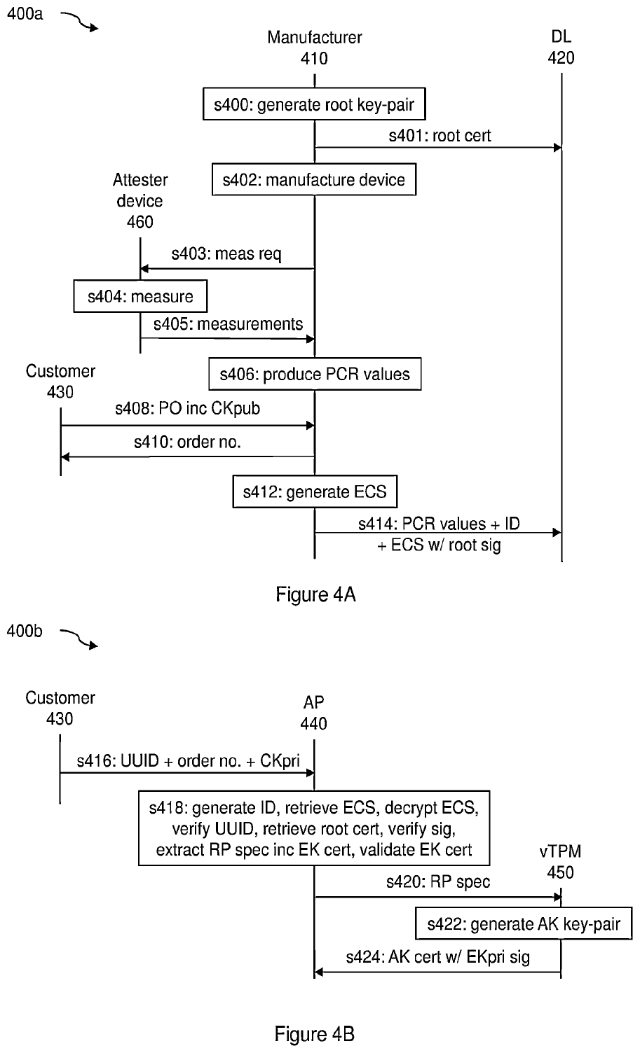

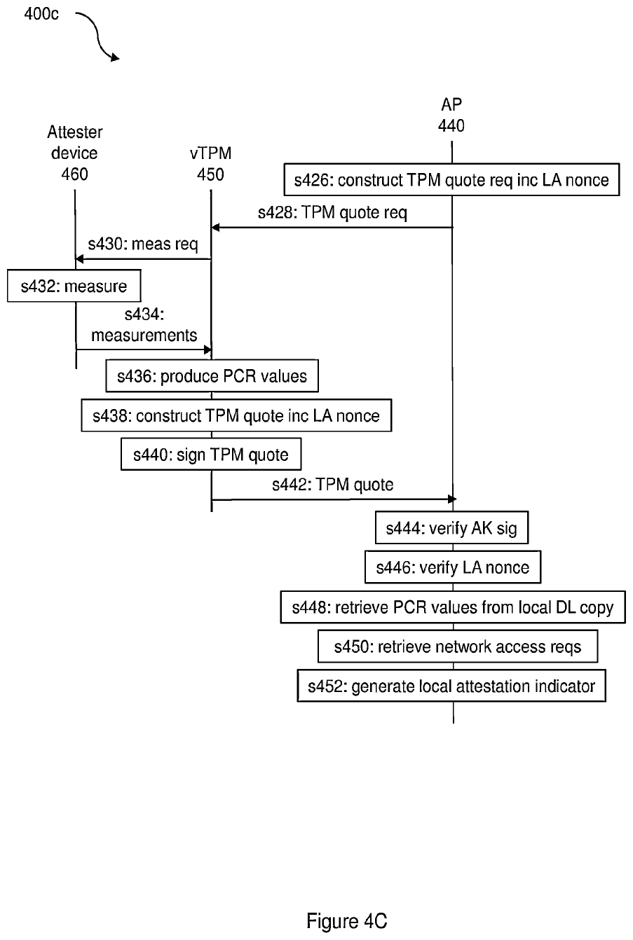

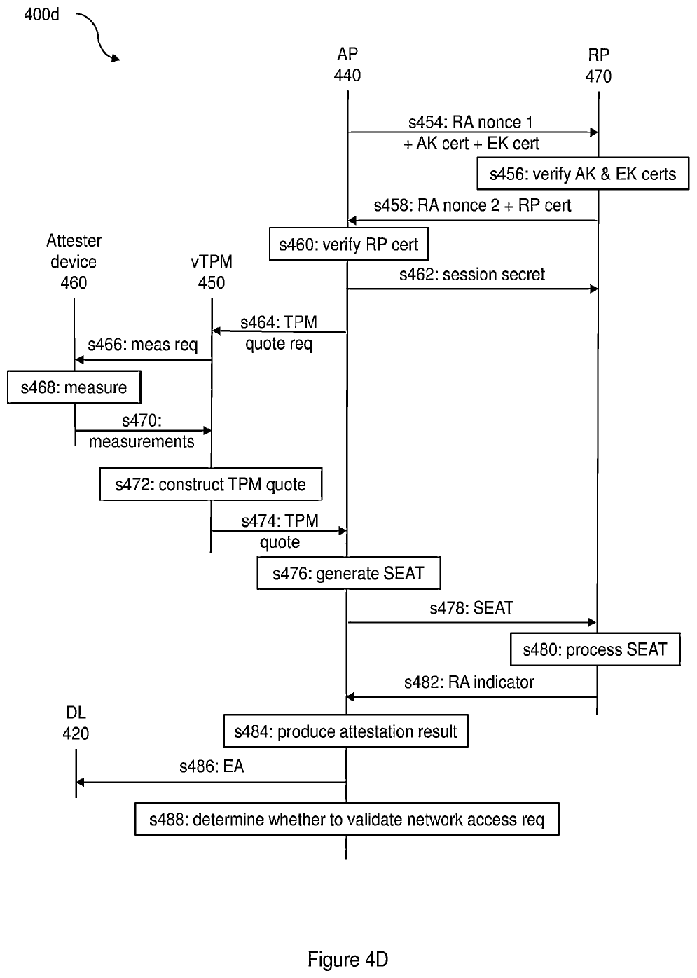

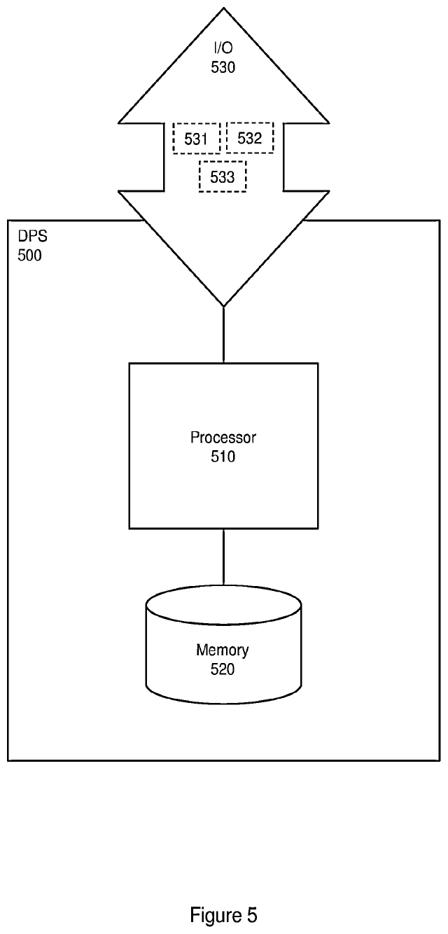

A complete example two-stage attestation protocol implementation will now be described with reference to FIGS. 4A to 4D.

FIG. 4A illustrates an example preparation process 400a.

At step s400 a manufacturer 410 generates a root public-private key-pair then publishes a root certificate to a DL 420 at step s401 so that the root public key is available on the DL.

A device 460 is manufactured by the manufacturer 410 at step s402. A measurement request is sent to the device 460 by the manufacturer 410 at step s403. The device 460 takes measurements at step s404 and provide them to the manufacturer at step s405. The manufacturer then uses the measurements to produce an initial set of PCR values at step s406. In this implementation the measurements are hashes of the device 460's firmware, boot loader and OS kernel as follows:

```
• Firmware, Version 1.2, “firmware.bin”,
  SHA256_Digest=0x11223344...
• Boot Loader, Version 3.4, “/EFI/boot.efi″,
  SHA256_Digest=0x55667788...
• Kernel Image, Version 5.6, ″/boot/vmlinuz-linux″,
  SHA256_Digest=0x99ABC...
```

The set of PCR values in this case is a single PCR value, generated by fold-hashing these three digests.

At step s408 a customer 430 sends a purchase order (PO) for the device 460 to the manufacturer 410. The PO comprises the customer 430's public key (CKpub).

At step s410 the manufacturer 410 provides the customer 430 with an order number (no.).

At step s412, the manufacturer 410 generates a unique encrypted claim state (ECS) object for the device 460. The claim state object comprises:
a universally unique identifier (UUID) for the device 460;
a device specification comprising:
   the manufacturer 410's name,
   a uniform resource locator (URL) for the manufacturer 410,
   a model name for the device 460,
   a model number for the device 460,
   hardware specifications for the device 460, and
   the device 460's network access requirements; and
an RP specification comprising:
   a URL for an RP server which is to be used for remote attestation of the device 460 (in this implementation a server of the manufacturer 410), and
   an EK key-pair unique to the device 460.

The claim state object is signed by the root private key so that any party with access to the root public key (e.g. via the certificate stored on the DL 420) can verify its origin. The claim state is encrypted using the customer's public key to ensure that any third party who obtains the claim state object cannot determine from it what the customer 430 has purchased. The ECS is indexed with a unique ID produced by hashing the UUID with the order number. The ECS and ID are signed with the root private key then published to the DL 420, together with the PCR values, at step s414.

FIG. 4B illustrates an example device on-boarding process 400b which follows the preparation process 400a.

At step s416 the customer 430 provisions an AP 440, for example running on their home's local network gateway, with the UUID of the device they have purchased (which may for example be printed on the device itself, e.g. in the form of a QR code sticker) as well as the order number and their private key (CKpri).

At step s418 the AP 440 performs several processes. First, it generates the ID index by hashing the UUID with the order number. The AP 440 is a node of the DL network 420 and, as such, stores a local copy of the DL from which it then retrieves the ECS using the ID index. It then decrypts the ECS using the customer 430's private key. The AP 440 then verifies that the UUID in the decrypted claim state corresponds to the UUID provided by the customer 430 a step s416. The AP 440 also retrieves the root certificate from its local copy of the DL so that it can verify the signature on the claim state object. Provided both these verifications are successful, the RP specification (spec), including the EK certificate, is extracted from the claim state object. The EK certificate is validated by confirming it bears a correct root signature.

At step s420 the RP spec is provided to a vTPM 450 constructed to handle attestation of the device. At step s422 the vTPM 450 generates an AK key-pair, then provides an AK certificate, signed with the EK private key comprised in the RP spec, to the AP 440 at step s424.

FIG. 4C illustrates an example local attestation process 400c which follows the device on-boarding process 400b.

At step s426 the AP 440 constructs a TPM quote request message comprising a local attestation nonce (LA nonce, a random number generated by the AP 440), which it then sends to the vTPM 450 at step s428. This prompts the vTPM 450 to request measurements from the attester device 460 at step s430 by querying its boot log for components measured (hashed) during boot at step s432. The attester device 460 provides the measurements (hashes of the device 460's firmware, boot loader and OS kernel) to the vTPM 450 at step s434. The vTPM 450 then produces a set of PCR values based on the measurements at step s436 (by fold-hashing the firmware, boot loader and OS kernel digests), constructs a TPM quote including the set of PCR values and the local attestation nonce at step s438 and signs the TPM quote using the AK private key at step s440 before sending it to the AP 440 at step s442.

The AP 440 verifies the TPM quote signature using the AK public key at step s444. At step s446 the AP 440 also verifies that the local attestation nonce received in the TPM quote matches that provided in the TPM quote request. Provided these two verifications are successful, the AP 440 retrieves the latest PCR values stored for the device on its local copy of the DL at step s448. At step s450 the AP 440 retrieves the attester device 460's network access requirements from the device specification (in the claim state decrypted at step s418). A local attestation indicator is then generated at step s452, based on both the network access requirements retrieved at step s450 and a comparison of the PCR values retrieved from the local copy of the DL at step s448 with the PCR values received from the vTPM 450 in the TPM quote at step s442.

FIG. 4D illustrates an example remote attestation process 400d which follows the local attestation process 400c.

At step s454 the AP 440 sends a first remote attestation nonce (RA nonce 1, a random number generated by the AP 440) to an RP 470 together with the AK certificate it received at step s424 and the EK certificate it extracted from the RP spec in the ECS at step s418. (The RP 470 is a node of the DL network 420 and, as such, stores a local copy of the DL.) At step s456 the RP 470 verifies the AK certificate using the EK certificate and verifies the EK certificate using the root certificate. The RP 470 then sends a second remote attestation nonce (RA nonce 2, a random number generated by the RP 470) to the AP 440, together with its RP certificate, at step s458. The AP 440 verifies the RP certificate, using the root certificate, at step s460. At step s462 the AP 440 shares a session secret with the RP 470, secured against third party access by encryption using the RP's public key from the RP certificate.

At step s464 the AP 440 sends a TPM quote request message, comprising the second remote attestation nonce, to the vTPM 450. This prompts the vTPM 450 to request measurements from the attester device 460 at step s466 by querying its boot log for components measured (hashed) during boot at step s468. The attester device 460 provides the measurements (hashes of the device 460's firmware, boot loader and OS kernel) to the vTPM 450 at step s470. At step s472 the vTPM 450 then produces a set of PCR values based on the measurements (by fold-hashing the firmware, boot loader and OS kernel digests) and constructs a TPM quote including the set of PCR values and second remote attestation nonce, signed using the AK private key, before sending it to the AP 440 at step s474.

At step s476 the AP 440 generates a symmetric entity attestation token (SEAT) as follows.
1. An entity attestation (EA) claim is generated, comprising:
   issue time
   expiry time
   RA nonce 1
   device UUID
   TPM quote
2. The session secret is split into two equal parts, SS1 and SS2, and used to convert the EA claim into a token by encryption using a symmetric cipher and a message authentication code (MAC), specifically:
   EAT=AES (SS1, EA)
   MEAT=HMAC (SS2, EAT)
   SEAT=EAT∥MEAT
   where AES is the advanced encryption standard and HMAC is a hash-based MAC.

The SEAT is then sent to the RP 470 at step s478, where it is processed at step s480 as follows.
The integrity of the MEAT is verified using SS2 (obtained from the session secret received at step s462) and EAT.
The EAT is decrypted using SS1 (obtained from the session secret received at step s462).
The issue time is checked to confirm it is later than when RA nonce 2 was sent from the RP 470 to the AP 440 at step s458.
It is confirmed that the expiry time has not yet been reached.
The first remote attestation nonce (RA nonce 1) received in the EAT is verified against that received by the RP 470 from the AP 440 at step s454.
The UUID is checked to confirm it matches that associated with the EK certificate received at step s454.
The second remote attestation nonce (RA nonce 2) received in the TPM quote is verified against that sent by the RP 470 to the AP 440 at step s458.
The set of PCR values received in the TPM quote is verified against the most recent set of PCR values in the RP 470's local copy of the DL.

A remote attestation indicator is generated by the RP 470 in dependence on the results of this processing and sent to the AP 440 at step s482. The AP 440 then produces an attestation result in dependence on the local and remote attestation indicators at step s484. The AP publishes the latest set of PCR values to the DL 420 at step s486, within an EA claim also comprising the UUID and issue time. Finally, at step s488 the AP 440 determines whether to validate the attester device 460's network access request, in dependence on the attestation result produced at step s484.

If the local attestation indicator generated at step s452 is negative then steps s454 to s482 may be dispensed with, the process proceeding directly to step s484.

### Suitable Data Processing System

FIG. 5 schematically illustrates an example data processing system (DPS) 500 capable of performing any of the methods described above. It comprises a processor 510 operably coupled to both a memory 520 and an interface (I/O) 530.

The memory 520 can optionally comprise computer program instructions which, when the program is executed by the processor 510, cause the data processing system 500 to carry out any of the methods described above. Alternatively or additionally, the interface 530 can optionally comprise one or both of a physical interface 531 configured to receive a data carrier having such instructions stored thereon and a receiver 532 configured to receive a data carrier signal carrying such instructions.

The receiver 532, when present, can be configured to receive messages. It can comprise one or more wireless receiver modules and/or one or more wired receiver modules. The interface 530 can optionally comprise a transmitter configured to transmit messages. The transmitter 533, when present, can comprise one or more wireless transmitter modules and/or one or more wired transmitter modules.

### Interpretation Notes

Embodiments of the invention will be apparent to those skilled in the art from consideration of the specification. It is intended that the specification be considered as exemplary only.

Where this application lists one or more method steps, the presence of precursor, follow-on and intervening method steps is not excluded unless such exclusion is explicitly indicated. Similarly, where this application lists one or more components of a device or system, the presence of additional components, whether separate or intervening, is not excluded unless such exclusion is explicitly indicated.

In addition, where this application has listed the steps of a method or procedure in a specific order, it could be possible, or even expedient in certain circumstances, to change the order in which some steps are performed, and it is intended that the steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The scope of the present invention includes any novel features or combination of features disclosed herein. The applicant hereby gives notice that new claims may be formulated to such features or combination of features during prosecution of this application or of any further applications derived therefrom. In particular, with reference to the appended claims, features from dependent claims may be combined with those of the independent claims and features from respective independent claims may be combined in any appropriate manner and not merely in the specific combinations enumerated in the claims.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus, or system to implement the foregoing described methods is envisaged as an aspect of the present invention. Such a computer program may be embodied as source code or undergo compilation for implementation on a processing device, apparatus or system or may be embodied as object code, for example.

Such a computer program may be encoded as executable instructions embodied in a carrier medium, non-transitory computer-readable storage device and/or a memory device in machine or device readable form, for example in volatile memory, non-volatile memory, solid-state memory, magnetic memory such as disk or tape, optically or magneto-optically readable memory such as magnetic tape, compact disk (CD), digital versatile disk (DVD) or other media that are capable of storing code and/or data. Such a computer program may alternatively or additionally be supplied from a remote source embodied in a communications medium such as an electronic signal, radio frequency carrier wave or optical carrier wave. Such carrier media are also envisaged as aspects of the present invention.

Such instructions, when executed by a processor (or one or more computers, processors, and/or other devices) may cause the processor (the one or more computers, processors, and/or other devices) to perform at least a portion of the methods described herein.

Where a processor is referred to herein, this is to be understood to refer to a single processor or multiple processors operably connected to one another. Similarly, where a memory is referred to herein, this is to be understood to refer to a single memory or multiple memories operably connected to one another.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, smartphones, tablets, network personal computers (PCs), minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

User devices can include, without limitation, static user devices such as PCs and mobile user devices such as smartphones, tablets, laptops, and smartwatches.

Receivers and transmitters as described herein may be standalone or may be comprised in transceivers. A communication link as described herein comprises at least one transmitter capable of transmitting data to at least one receiver over one or more wired or wireless communication channels. Wired communication channels can be arranged for electrical or optical transmission. Such a communication link can optionally further comprise one or more relaying transceivers.

User input devices can include, without limitation, microphones, buttons, keypads, touchscreens, touchpads, trackballs, joysticks, mice, gesture control devices and brain control (e.g. electroencephalography, EEG) devices. User output devices can include, without limitation, speakers, buzzers, display screens, projectors, indicator lights, haptic feedback devices and refreshable braille displays. User interface devices can comprise one or more user input devices, one or more user output devices, or both.

1. An attestation method for verifying the integrity of an attester device by an attestation proxy (AP):
sending a trusted platform module (TPM) quote request message directly to a virtual TPM (vTPM) uniquely associated with the attester device, to prompt the vTPM to:
produce a set of platform configuration register (PCR) values based on measurements requested and received by the vTPM directly from the attester device,
then send a TPM quote comprising the set of PCR values directly to the AP;
the attestation method further comprising the AP:
receiving the TPM quote;
sending the TPM quote to a remote relying party (RP) to prompt the RP to:
verify the TPM quote is as expected,
then return a remote attestation indicator to the AP;
receiving the remote attestation indicator; and
producing an attestation result based on the remote attestation indicator, wherein the attestation result is negative when the remote attestation indicator is negative.

2. The attestation method of claim 1, further comprising the AP:
obtaining an indication that a user wishes the attester device to join a network in which the AP is comprised, the step of sending the TPM quote request message being in response to obtaining said indication; and
determining whether to validate the attester device for joining the network in dependence on the attestation result, wherein the AP prevents the attester device from joining the network when the attestation result is negative.

3. The attestation method of either of claim 1, wherein the AP is a node of a distributed ledger (DL) network and the RP has read access to the DL, the attestation method further comprising the AP:
publishing the set of PCR values received in the TPM quote to the DL.

4. The attestation method of claim 3,
further comprising the AP retrieving the attester device's network access requirements from the DL;
wherein the attestation result is produced based on said network access requirements.

5. The attestation method of claim 2, wherein the AP is a movable network element which resides on a network-attached device, the attestation method further comprising:
determining that performance of the network-attached device on which the AP resides does not satisfy an AP performance criterion; and
responsive thereto, initiating transfer of the AP to an alternative network-attached device.

6. The attestation method of claim 2, wherein the vTPM is a movable network element which resides on a network-attached device, the attestation method further comprising:
determining that performance of the network-attached device on which the vTPM resides does not satisfy a vTPM performance criterion; and
responsive thereto, initiating transfer of the vTPM to an alternative network-attached device.

7. The attestation method of claim 1, further comprising the AP:
prior to sending the TPM quote to the RP, establishing a communication session with the RP by sending a first remote attestation nonce to the RP and receiving a second remote attestation nonce from the RP; and
sending the first and second remote attestation nonces to the RP together with the TPM quote, to prompt the RP to verify the first and second remote attestation nonces it received together with the TPM quote match the first and second remote attestation nonces previously exchanged with the AP, wherein the attestation result is negative when verification of either of the first and second remote attestation nonces fails.

8. The attestation method of claim 1, further comprising the AP, prior to sending the TPM quote to the RP:
securely sending a session secret to the RP; and
encrypting the TPM quote using a symmetric cipher based on the session secret.

9. The attestation method of claim 1,
wherein the AP is a node of a distributed ledger (DL) network, that DL network being the DL network of claim 3 when dependent thereon;
the attestation method further comprising the AP:
retrieving, from a local copy of the DL, a latest set of PCR values recorded for the attester device; and
comparing that set of PCR values retrieved from the local copy of the DL with the set of PCR values received in the TPM quote to produce a local attestation indicator, wherein the local attestation indicator is negative when the set of PCR values retrieved from the local copy of the DL does not match the set of PCR values received in the TPM quote;
wherein the attestation result is negative when the local attestation indicator is negative.

10. A data processing system configured to perform the attestation method of claim 1.

11. A network gateway device comprising the data processing system of claim 10.

12. A computer program comprising instructions which, when the program is executed by a computer, cause the computer to carry out the method of claim 1.

13. A computer-readable data carrier having stored thereon the computer program of claim 12.

14. A data carrier signal carrying the computer program of claim 12.
